(19) United States
(12) Patent Application Publication
(10) Pub. No.: US 2005/0269491 A1
(43) Pub. Date: Dec. 8, 2005

(54) Carrier with at least one transilluminated optical position mark

(76) Inventors: Konrad Slanec, St. Julians (MT); Marvin Zammit, Sliema (MT)

Correspondence Address: JACOBSON HOLMAN PLLC, 400 SEVENTH STREET N.W., SUITE 600, WASHINGTON, DC, 20004, US

(21) Appl. No.: 11/143,457

(22) Filed: Jun. 3, 2005

(30) Foreign Application Priority Data
Jun. 3, 2004 (DE) 10 2004 027 226.3

(51) Int. Cl. G01D 5/34

(52) U.S. Cl. 250/231.13; 250/231.14

(57) ABSTRACT

A carrier (2) with optically transilluminated position marks (3) can be positioned between a source of light (5) and an optical detector (4). The position mark (3) is built as an optical element that deflects the beam of light, which leads to significant variations in the intensity of light (8) at the central area of the image in the detector plane. With that, it is possible with less fabrication costs to furnish a measuring device that is robust against interfering influences.

The invention relates to a carrier with at least one transilluminable optical position mark, which can be positioned between a light source and an optical detector.

For example, in the determination of the angle of rotation it is common to provide the disk-shaped carrier, built as a mask with periodic, series of transilluminated gaps, whose image is formed with intensity variations depending on their relative positions, on the optical detector.

The resolution of an encoder is determined, among other things, by the width of these gaps. The contrast is impaired due to the scattering and the diffraction effects, which influences the minimum width of the gaps. Since the encoder disk cannot be made arbitrarily thin due to reasons of stability, it is difficult to construct arbitrarily small slits, for example, by means of pressing technique. Moreover, due to the scattering and the diffraction effects, it is also necessary to keep the distance from the detector as small as possible and to adjust it precisely, which requires a stable construction involving time-consuming assembly and justification. In order to achieve a good contrast, the distance between the gaps should also be approximately same as their widths, which requires the corresponding large divisions in the graduation scale. Contaminations, for instance in the form of adhesive particles, direct mess up the intensity distribution.

The underlying task posed by the invention was to reduce the fabrication costs and to increase the functional reliability.

This task is solved by the characteristics mentioned in the preamble of claim 1. For example, the optical element to be focused leads to the result that the position mark is imaged with a very small size on a narrow detector window, which appears then with the corresponding high light intensity at the center of the image and strong decline on both sides away from the center. This means, for example, that the upper threshold value of the measurement has a narrow width, which enables the corresponding finer allocation of the position. Particularly good contrast is obtained, if the mask lies in the plane of the focus. But even in case of larger variations, the intensity curve has a flatter, but nevertheless a clear waveform. Since the optical element integrates a larger area, the influence of contamination is reduced. Through the collimation of the beam of light, the dependence of the intensity distribution on the distance of the detector can be reduced significantly. Due to the insensitivity, the mechanical and the fabrication technical requirements on the measuring device indicating the position mark are low.

Further advantageous embodiments of the invention follow from the characteristics stated in the claims 2 to 8.

The position mark according to claims 2 and 3 has especially favorable optical features and can be fabricated easily.

In carriers according to claims 4 and 5, the position marks can be furnished without involving additional production steps in injection molding process for instance, whereby the position marks can also be built as sphere-like elevations.

With the further enhancement according to claim 6, the graduation scale width between the position marks can be reduced to a minimum with high image sharpness.

The waveform according to claim 7 leads to alternating focusing and dispersion with very large differences in the contrast.

The enhancement according to claim 8 represents a particularly suitable application, in which the position marks on the compact, disc-like carrier can be imaged with less effort. Such type of encoder can thus be integrated more easily in a miniaturized rotary module.

A demonstrative example of the invention is shown in the drawing and is explained in detail in the following. Shown are:

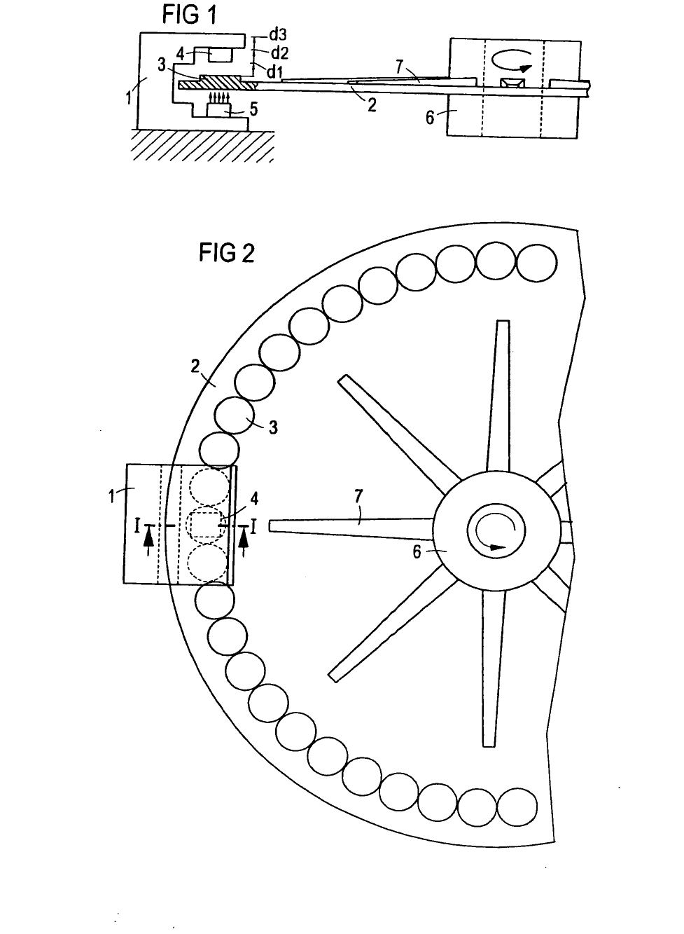

FIG. 1 A side view, showing a partial section along line I-I in FIG. 2, of an angle measurement device according to the invention,

FIG. 2 A top view of the angle measurement device according to FIG. 1,

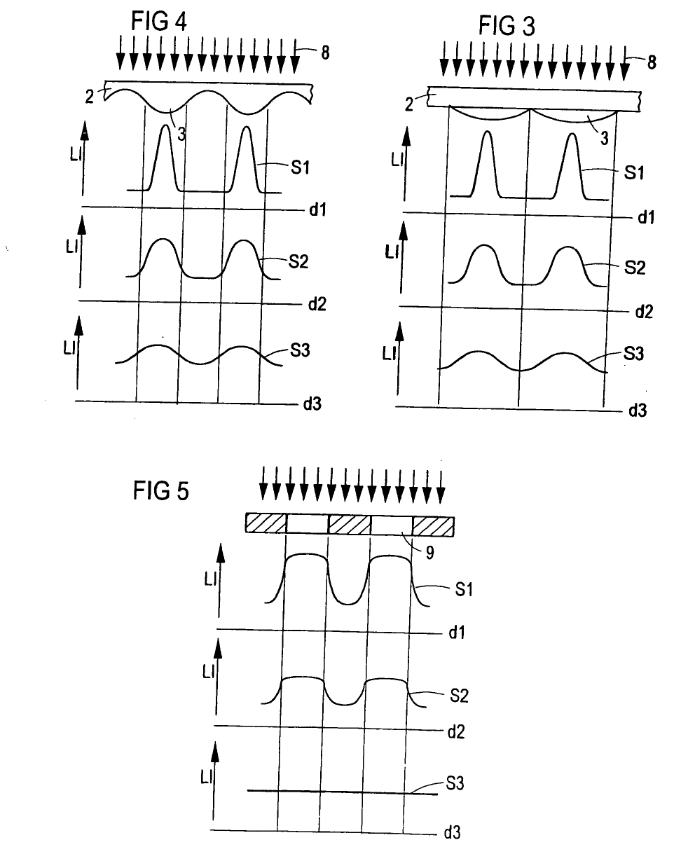

FIG. 3 A schematic functional diagram of an angle measurement device according to FIGS. 1 and 2,

FIG. 4 A schematic functional diagram of another angle measurement device according to the invention,

FIG. 5 A schematic functional diagram of an angle measurement device according to the current state-of-the-art

According to FIGS. 1 and 2, an angle measuring device consists of a stationary measuring head 1 and a disk-shaped rotatable carrier 2, with concentric, periodically distributed, position marks 3, built as cylindrical lenses, which form the angle measurement scale. The measuring head comprises an optical detector 4 on one side of the carrier 2 in the area of the position marks 3, and a source of light 5 on the opposite side, which radiates in the direction of the detector 4. The position marks 3, which form the counter scale, are built as one-piece cylindrical embossing on the transparent carrier 2 on the side of the detector 4 and are bordering each other immediately with small space between the graduations. Several tracks of the position marks, with the corresponding multiple detector, can also form a coded position scale.

The detector 4 is provided with a detector window, not shown here, which is narrower compared to the position mark 3, for exact determination of the position and is in position to differentiate exactly between varying light intensities. For better position allocation, it also possible to combine, at least two of the detectors, into a position resolving, line sensor extending in the direction of rotation.

The detector window is arranged here at distance d1 from the free facing side of the cylinder lens at its focus. The distance can be increased, for instance, to d2, without jeopardizing the accuracy of the measurement significantly. A further distance d3, for which it is still possible to evaluate detector signals, serves the purpose, above all, of subsequently showing the difference from the position mark according to the current status-of-the-art.

The carrier is provided at its center with a hub 6 for rotation-proof connection with the wave, not shown in detail here, whose position of the angle or change of the angle is to be monitored. Between the hub 6 and the position marks 3, extend radial reinforcing ribs 7 arranged in star-shaped form.

The FIGS. 3 to 5 show the distribution of the light intensity LI in the detector plane over the scanned track, with the corresponding different types of the position marks at distances d1, d2, d3.

FIG. 3 shows a section of the carrier 2, whereby, here, the position marks 3 are shown as elevated calotte shells for better recognition. At distance d1, there is the receiver window of the detector at the focus of the position mark 3 built as a convex lens. Light 8 coming from the source of light 5 (FIG. 1) is bundled by the convex lens so strongly that at the center of the position mark a very highly light intensity LI predominates, which declines rapidly on both sides away the center and declines to the lowest value already within the marking region. This type of prominently distinct signal S1 is especially robust against external interferences. At distance d2, the signal s2 is flatter, but still distinct, and is clear enough to be registered easily. Also at distance d3, the distribution of light intensity is still clearly recognizable as a wave shaped signal S3.

According to FIG. 4, the position mark in the carrier 3 is formed as a wave on the side of the carrier facing the detector. Several waves are positioned in a row one after another in such fashion that a continuous line of waves is obtained at the center in which the focusing concave and the diverging convex parts alternate one after another. Thereby the intensity distribution, which is similarly distinct as the one at the position mark according to FIG. 3, is obtained.

FIG. 5 shows the familiar position marks in the form of the simple slit type apertures 9 in an intransparent carrier. For the narrow distance d1, the difference of the light intensity LI is till clearly distinct as signal S1, however not so sharp focused as in FIGS. 3 and 4. In order to achieve similar high level differences, a strong light source is necessary. The maximum of the signal S1′ can be associated less exactly with the position of the marks. At distance d2, the intensity difference between the maximum and the minimum in the form of the signal S2′ is already significantly evened out due to scattering and diffraction effects and at distance d3, it is already no longer present. The curve of the corresponding signal S3′, no longer evaluable, is thus a straight horizontal line.

1. Carrier with at least one optically transilluminable position mark (3), which can be positioned between a light source (5) and an optical detector (4), characterized in that, the position mark (3) is built as an optical element that deflects light rays, and which leads to significant variations in the intensity of the light (8) at the central area of the image in the detector plane.

2. Carrier according to claim 1, characterized in that, the position mark (3) is constructed as a convex lens.

3. Carrier according to claim 2, characterized in that, the position mark (3) is constructed as a cylindrical lens.

4. Carrier according to claim 1, characterized in that, the position mark (3) is built as a one-piece on the transparent carrier (2).

5. Carrier according to claim 1, characterized in that, the carrier (2), which serves as encoder has a number of position marks (3) in a row one after another forming a measurement scale.

6. Carrier according to claim 5, characterized in that, the position marks (3) at the transparent carrier (2) are positioned in a row one after another almost without intervening gaps.

7. Carrier according to claim 6, characterized in that, the position marks (3) are built in wavelike form and are in a continuous row one after another in the form of a line of waves at the carrier (2).

8. Carrier according to claim 5, characterized in that, the carrier (2) is built as an injection molded part and that the position marks (3), arranged concentrically about an axis, form a scale for angle measurement.

9. Carrier according to claim 2, characterized in that, the position mark (3) is built as a one-piece on the transparent carrier (2).

10. Carrier according to claim 3, characterized in that, the position mark (3) is built as a one-piece on the transparent carrier (2).

11. Carrier according to claim 2, characterized in that, the carrier (2), which serves as encoder has a number of position marks (3) in a row one after another forming a measurement scale.

12. Carrier according to claim 3, characterized in that, the carrier (2), which serves as encoder has a number of position marks (3) in a row one after another forming a measurement scale.

13. Carrier according to claim 4, characterized in that, the carrier (2), which serves as encoder has a number of position marks (3) in a row one after another forming a measurement scale.

14. Carrier according to claim 6, characterized in that, the carrier (2) is built as an injection molded part and that the position marks (3), arranged concentrically about an axis, form a scale for angle measurement.

15. Carrier according to claim 7, characterized in that, the carrier (2) is built as an injection molded part and that the position marks (3), arranged concentrically about an axis, form a scale for angle measurement.
